(19) United States
(12) Patent Application Publication
(10) Pub. No.: US 2008/0215533 A1
(43) Pub. Date: Sep. 4, 2008

(54) Method for interfacing application in an information search and retrieval system

(75) Inventor: Petter Moe, Billingstad (NO)

Correspondence Address: BIRCH STEWART KOLASCH & BIRCH, PO BOX 747, FALLS CHURCH, VA, 22040-0747, US

(73) Assignee: FAST SEARCH & TRANSFER ASA

(21) Appl. No.: 12/068,512

(22) Filed: Feb. 7, 2008

(30) Foreign Application Priority Data
Feb. 7, 2007 (NO) 20070718

(51) Int. Cl. G06F 17/30

(52) U.S. Cl. 707/2; 707/E17.017

(57) ABSTRACT

In a method for interfacing search, analysis, and report applications in an information search and retrieval system with a complex structured record or content repository, a schema discovery is performed on the basis of a search application, schema paths associated with a search result are extracted, and summary information of the extracted schema paths is computed.

The invention concerns a method for interfacing information search, analysis, and report applications in an information search and retrieval system with a structured record or content repository containing complex structured records or content, wherein the repository is searchable and comprises schema paths for record or content attributes.

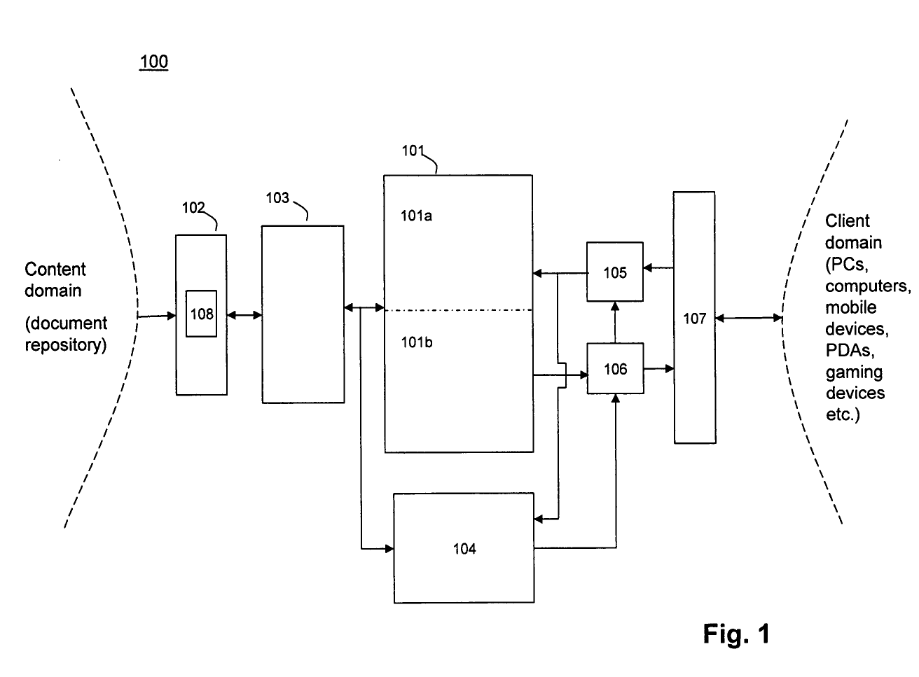

The present invention specifically relates to search applications in enterprise search systems, and for illustrative purposes a search engine as known in the art and used in enterprise search systems shall now briefly be discussed with reference to FIG. 1. A search engine 100 as used with the present invention comprises as known in the art various subsystems 101-107. The search engine can access document or content repositories located in a content domain or space wherefrom records or content can either actively be pushed into the search engine, or via a data connector be pulled into the search engine. Typical repositories include databases, sources made available via ETL (Extract-Transform-Load) tools such as Informatica, any XML formatted repository, files from file servers, files from web servers, document management systems, content management systems, email systems, communication systems, collaboration systems, and rich media such as audio, images and video. The retrieved documents are submitted to the search engine 100 via a content API (Application Programming Interface) 102. Subsequently, documents are analyzed in a content analysis stage 103, also termed a content preprocessing subsystem, in order to prepare the content for improved search and discovery operations. Typically, the output of this stage is an XML representation of the input document. The output of the content analysis is used to feed the core search engine 101. The core search engine 101 can typically be deployed across a farm of servers in a distributed manner in order to allow for large sets of documents and high query loads to be processed. The core search engine 101 can accept user requests and produce lists of matching documents. The document ordering is usually determined according to a relevance model that measures the likely importance of a given document relative to the query. In addition, the core search engine 103 can produce additional metadata about the result set such as summary information for document attributes. The core search engine 101 in itself comprises further subsystems, namely an indexing subsystem 101a for crawling and indexing documents or content, and a search subsystem 101b for carrying out search and retrieval proper. Alternatively, the output of the content analysis stage 103 can be fed into an optional alert engine 104. The alert engine 104 will have stored a set of queries and can determine which queries that would have accepted the given document input. A search engine can be accessed from many different clients or applications which typically can be mobile and computer-based client applications. Other clients include PDAs and game devices. These clients, located in a client space or domain, will submit requests to a search engine query or client API 107. The search engine 100 will typically possess a further subsystem in the form of a query analysis stage 105 to analyze and refine the query in order to construct a derived query that can extract more meaningful information. Finally, the output from the core search engine 103 is typically further analyzed in another subsystem, namely a result analysis stage 106 in order to produce information or visualizations that are used by the clients. —Both stages 105 and 106 are connected between the core search engine 101 and the client API 107, and in case the alert engine 104 is present, it is connected in parallel to the core search engine 101 and between the content analysis stage 103 and the query and result analysis stages 105; 106.

For the purposes of the present invention the terms document will be used synonymously with record, which will be used to denote the objects constituting a database, thus avoiding the connotation of a document as a textual entity only. Further in an enterprise environment a certain comprehensive record set hereinafter primarily will be regarded as a database, and this database is not only structured, but also the records thereof in themselves shall be structured or even have a complex structure. This contrasts strongly with document repositories as encountered in open systems such as on the World Wide Web where the information is available from an immense number of highly diversified sources, and wherein the information providers form a most heterogeneous body. Moreover, much of this information is unstructured and present in the form of either textual documents or various rich media such as audio and video, as well known to users of the World Wide Web.

In the context of an enterprise the information generated or owned by the enterprise may be scattered in one or more databases that typically are distributed over a number of storage devices and managed by the servers of the enterprise, which moreover shall support and serve any client-generated applications in the enterprise. The databases are usually structured and in addition the stored records in themselves usually display a highly complex internal structure. A typical instance would be records comprising tables or lists with a mixture of numerical and textual information and with a large number of attributes that are assigned to equally large or even larger structural elements of the records. The tables and the attributes can be regarded as forming an information set of the database.

Currently, an administrator uses a database management tool to inspect the tables and attributes of an information set in order to configure an index. Since attribute names are often less than readable, a preview of data is provided to ease the task of the administrator in selecting attributes. This process is called schema discovery. In large enterprise systems, there may be tens of thousands of tables, each with hundreds of attributes. Hence, schema discovery can be a complex and time-consuming process.

Thus a primary object of the present invention is to provide search-driven schema discovery that avoids or eliminates the above-mentioned disadvantages of the current methods for schema discovery.

Another object of the present invention is to enable the specification of information retrieval on the basis of the schema discovery.

Yet another object of the present invention is to improve and simplify result navigation with information from the schema discovery.

Finally, it is also an object of the present invention to improve search applications by deploying means derived from a schema discovery process.

The above objects as well as further features and advantages are realized with a method according to the present invention which is characterized by comprising steps for applying a search query for one or more attribute values, extracting schema paths associated with matching records or content in a search result for the applied search query, and computing summary information of the extracted schema paths.

In an advantageous embodiment of the present invention the computed summary information is used for constructing an information retrieval specification.

In another advantageous embodiment of the present invention the computed summary information is used as an aid for result navigation in the information search and retrieval system.

Finally, in yet another advantageous embodiment of the present invention, access information relating to a performed search application is gathered by means of the computed summary information, one or more access templates are established on the basis of the gathered access information, and said one or more access templates are deployed in the information search and retrieval system for improving future search applications in the systems.

Additional features and advantages shall be apparent from the remaining appended dependent claims.

The present invention shall be better understood when the following detailed description of certain embodiments of the present invention is read in conjunction with the appended drawings, of which

FIG. 1 illustrates a block diagram for a simplified search engine architecture,

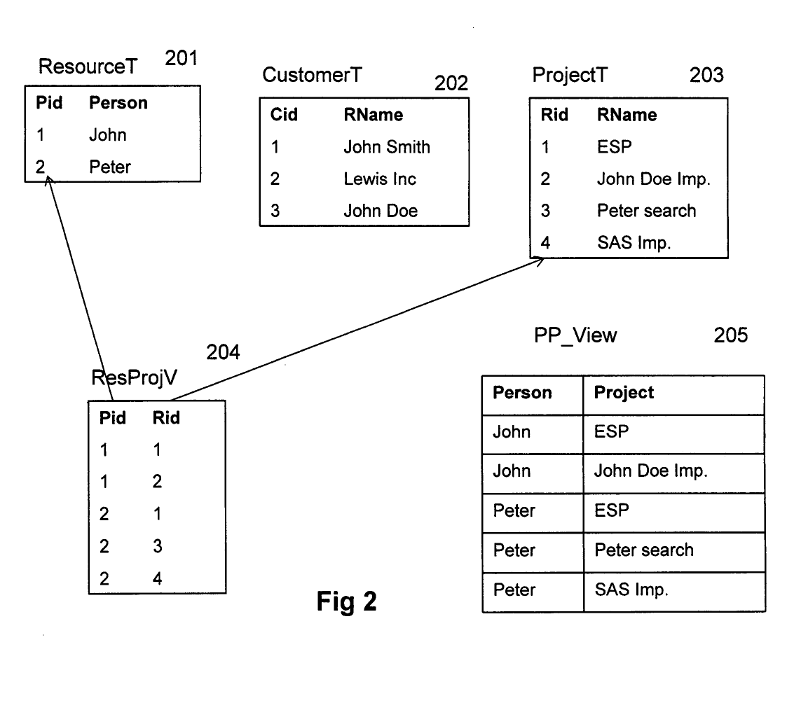

FIG. 2 shows a very minimal example of tables with values,

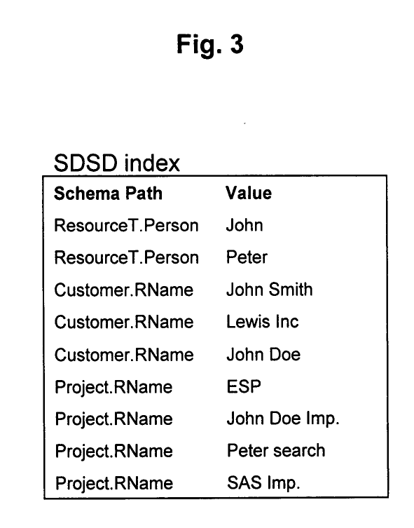

FIG. 3 how the attribute values from FIG. 2 can be represented in an index to support search-driven schema discovery,

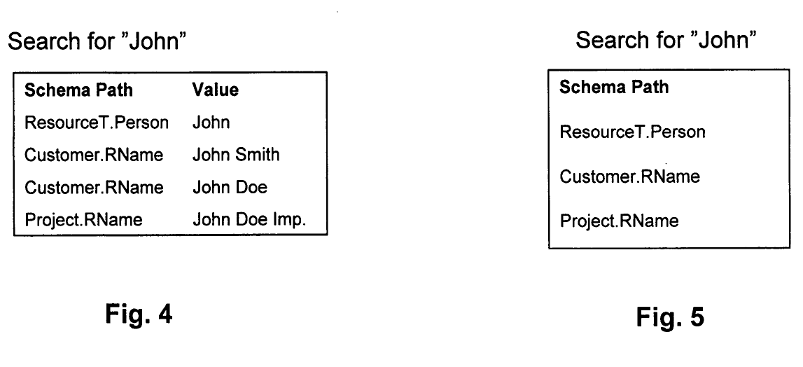

FIG. 4 one example of a result set comprising of schema paths and actual values of an exemplary search,

FIG. 5 a simplified presentation of the result set in FIG. 4, with the actual values not shown, and duplicate values for schema paths removed,

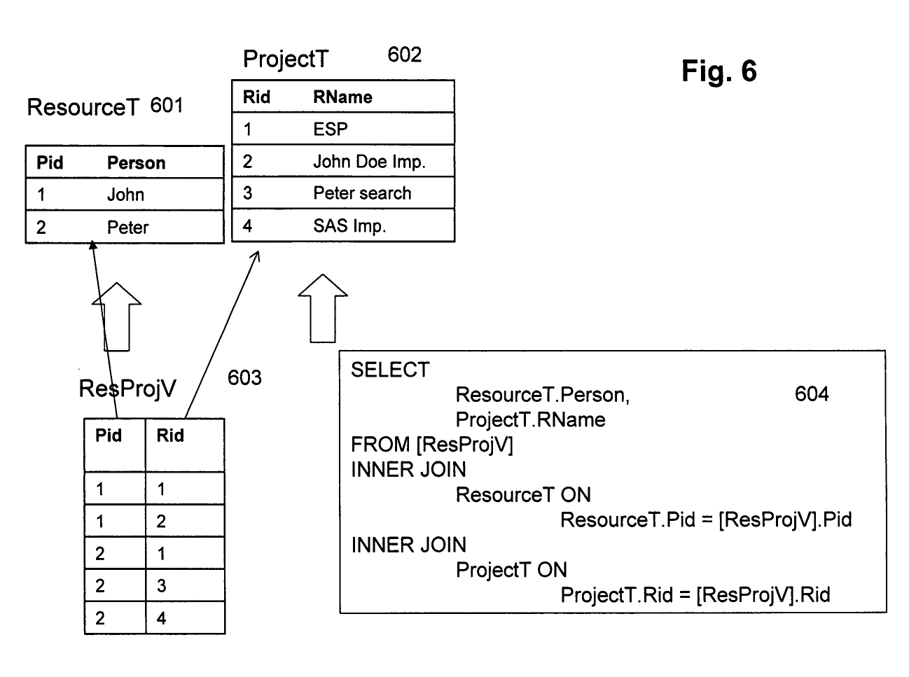

FIG. 6 how different tables may be joined, and

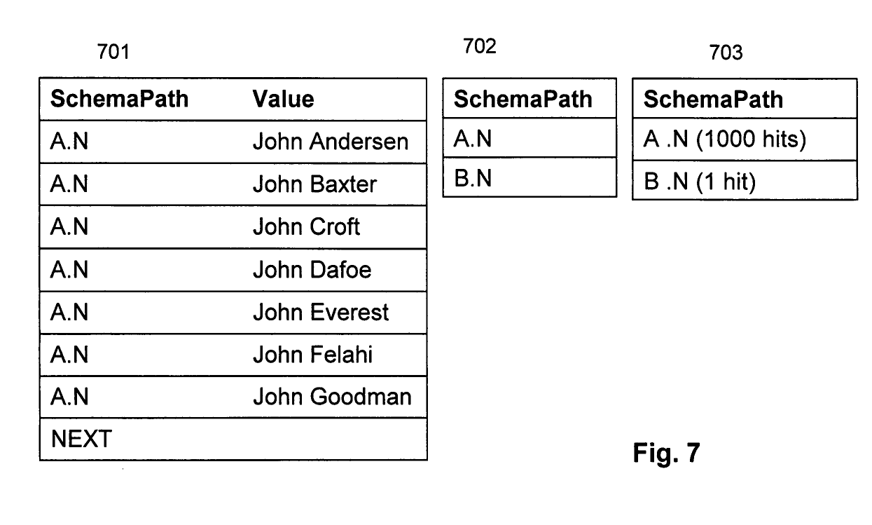

FIG. 7 the presentation of results including occurrence frequencies in the schema path.

Before turning to a discussion of preferred embodiments the general background of the present invention shall be briefly described. As an example, imagine that the administrator of a time and expense system wants to generate a list of which of his resources that were assigned to or worked on what projects. With current technology, the schema discovery would be a navigational process, where one must first select a database, then a table within that database, and following this, scrutinizes attribute names or values within that table. The names will often not be intuitive, and there are many to choose from, so this is a time-consuming and frustrating process.

With search-driven schema discovery, the process changes fundamentally. Imagine a database similar to that depicted in FIG. 2. The administrator starts by specifying an example of one of the fields needed in the result. “I do not know where this entity is represented, but I do know that I have one such entity that is named ‘John’”. FIG. 2 can be taken to illustrate a very minimal example of tables 201 ResourceT, 202 CustomerT, and 203 ProjectT with values, and shows in the table 204 “ResProjV” how tables can be joined. The table 205 “PP_View” shows how the user would perceive the data from this relation. The value “John Smith” has the schema path “DB_X.CustomerT.RName” The schema path “DB_X.ResourceT.Person” addresses the values “John” and “Peter”, and shows how attribute values from FIG. 2 can be represented in an index SDSD to support search-driven schema discovery which exemplifies a result set of schema paths and natural values as found in a search application. This index is shown in FIG. 3 and presents a complete map of such values, as given by tables 201, 202, 203 in FIG. 2. Based on that, the schema discovery system will report back the different database-table-attribute triplets that have at least one value that matches that name, as depicted by the list in FIG. 4 and shown simplified in FIG. 5 by presenting a result navigation instead of complete results. Based on that, the administrator can now select which value is the correct one.

This process is repeated for each of the fields wanted in the result set. As new fields are added to this set, the system looks at ways of joining over the named attributes, or other attributes in the same records, to provide a unified record definition, containing all the fields.

Based on this joining, the system can also offer other attributes that exist in those joined tables, and which could be candidates for adding to the result set.

For structured information sources, a record contains a set of attributes. Each of these attributes has a name, which is common across all records. For each record, each attribute also has a value, which may or may not be unique for each record, and may be null (not set), contain a single value, or contain a set of values. Preferably only single values are kept for unique attributes of records in the repository.

The set of attributes for each record set is referred to at the schema of the record set or table.

A set of records can be referred to as a record set. If the record set contains all the records with the same schema for an information set, the set is often implemented as a database table.

Search is the process to find a record, based on a partial specification of one or more of its attributes. To improve the performance of a search application, an index is often created, based on one or more content sources. The process of filling an index with information is called content capture, and any analysis of the data is referred to as content refinement.

In regard of the search application proper, i.e. whereby information is retrieved from the database by applying a search query to the searchable database, and having the search application processed by a search engine as e.g. discussed in the introduction of the application, the search result may be retrieved on the basis of an identical or exact match, or a partial or approximate match or by being included in a concept class for one or more attribute values. In the latter case a concept class can be specified as a person and organization. Also the search query can be applied with a linguistic normalization in order to improve recall in the search result, recall being a measure of the returned records in the search result. If linguistic normalization is applied to the search query, this can preferably be done with for instance lemmatization, common spell checking, phonetic matching, synonyms or homeosemies, the latter being near-synonyms. All these preferable measures in connection with a search application can be considered well-known to persons skilled in art of information search and retrieval.

Structured sources typically contain a set of database tables, of which some may need to be joined in order to produce searchable items. The process of selecting such tables, configuring which values to join over, and selecting which records to feed to the index is called index configuration. In order to meaningfully configure an index, an administrator needs to understand the schema of the data tables.

Currently, an administrator uses a database management tool to inspect the tables and attributes of an information set in order to configure an index. Since attribute names are often less than readable, a preview of data is provided, to ease the task of the administrator, in selecting attributes. This process is called schema discovery.

The schema path of an attribute is an exact description of where an attribute can be found. This would in a database typically contain a) the server where the database resides, b) the name of the database, c) the name of the table, and d) the name of the attribute, or in an alternative notation “server.db.table.attribute”.

Particularly the method of the present invention shall enable use search driven schema discovery for unravelling the schema of a SQL database. In current database system, schema discovery involves using a database management system to manually inspect each or a subset of tables, chosen by name, to see if the values are the ones needed. In large enterprise systems, there may be tens of thousands of tables, each with hundreds of attributes. Hence, as stated above, schema discovery can be a complex and time-consuming process. Also, in such systems naming conventions typically determine what names that can be used for all entities, so that the names are typically not intuitive to a human user. With the present invention, the user would start with examples that are known to exist in the data, run queries based on those, and the search system would offer up candidate attributes for the user to inspect.

The method of the present invention is used to discover the structure of data stored in XML. In a current XML-based system, a user would manually run XQuery queries or using an XQuery-based browser to inspect contents of the system. The present invention would index the underlying information, and let the user run a search, resulting in candidate locations for the information needed.

In a preferred embodiment of the present invention a specification of the information retrieval is constructed. How this is done is depicted in FIG. 6. One attribute is selected from the table 601 “ResourceT”, and one attribute from the table 601 “ProjectT”. Now it can be determined from the database schema that these tables can be joined over the table 601 “ResProjV”, and based on this relationship the information retrieval specification 604 is generated as shown. As shown in FIG. 6 it is seen that in this example the information retrieval specification 604 takes the form of an SQL statement

In this embodiment the search driven schema discovery can be used for facilitating migration of enterprise software systems. With prior art technology, a company which wants to upgrade an enterprise software system would need to go through a manual process where the structure of the incumbent system is inspected to uncover adaptations and patterns of use. This must then be reflected into the new system. For large companies moving from one Enterprise Resource Planning (ERP) vendor to another, this task is known to involve investments of many millions of dollars, and take several years. Schema discovery is a significant part of this cost. This whole process is built upon a good understanding of the actual underlying schema, and could be made much more efficient by search driven schema discovery.

Also, an information retrieval specification as generated in this first embodiment of the present invention can be used to reduce the cost of generating reports in an enterprise software system. With current technology, a manual process of selecting tables to be used as a basis for reports is time-consuming and error-prone. With the method of the present invention, the selection process would be example driven. Take an example where a user needs to create a report of sales to customers. With current technology, the user would start looking at the table names or the view names, probably looking for table names containing terms like “sale” or “customer”. If such a table is found, the user will look at the values to check if it is likely that the information found is the correct one. This process becomes immensely cumbersome in systems where the naming conventions are not intuitive, since the user may have to preview all tables in the system. This process is also error-prone, because there are many cases where similar data are held in multiple tables, and are used for slightly different purposes. A system based on the present invention would ask the user for an example of such a customer, for instance “ACME”. A search would then be executed and the result could be that “this name occurs in the following tables: current_customers, former_employers, and marketing_partners”. From this selection the user would know straight away which one to base the report on. If the same tables were hidden under the names XCC_{—}1543, XCB_{—}2063, and XAA_M15, in a system also containing another 20 000 tables, the ability to focus in on such a small subset is essential to get the job done.

The method of the present invention shall provide a simplification of the process of selecting a subset of tables and attributes in order to make them searchable in a search index. With current technology, the schema must either be known a-priori or the same cumbersome manual discovery process must be performed. With search-driven schema discovery, a candidate subset is returned typically in the form of drilldowns, which allows the user select the desired attributes.

When presenting a list of results, the most common representation is a list of results. This becomes awkward where there are many results available, since the results that are really needed can occur lower in the list than a great number of other hits. As an example, imagine that the present invention is used to search for the value “John”, and that the tables contain 1000 references including “John” in table A, and only on in table B. A result presentation without navigation would require the user to go through all the hits from table A before finding the hits from table B. This is depicted as the list 701 in FIG. 7. The “NEXT” button lets the user see the next subset.

In another preferred embodiment of the present invention presents result not as a list, but as result navigation. Briefly stated the result navigation is presented as an associated list of schema paths. The improvement here would provide a grouping on the tables, and allow the user to select “A” or “B” to navigate to the only record which match this specification by using the schema path 702 shown in FIG. 7. A further improvement of this, counts the result to show the user the number of matching results for each navigation option, as presented in the schema path 703, thereby allowing occurrence frequency information to be included in the list of schema paths.

Yet another preferred embodiment of the present invention shall provide a greatly reduced effort and also reduce the initial time for making large repositories searchable. Without indexing, searching in large repositories typically involves a scan of the data, a very time-consuming process. Even with current technology, records to be made searchable are typically de-normalized to combine values which shall be searched for together. With the method of the present invention and a search system supporting joining, one would first index all the primary values, i.e. non-repeated values in individual attributes of the data warehouse. Then a complex search could be executed against each attribute and the results joined to find the actual result.

The method of the present invention would then be applied to expose the combination of attributes used in actual searches. This information could subsequently be used to create a physical index of those combinations of attributes which are actually searched for, thus using an observed search pattern as a so-to-say template for access optimization. With this system in place, the user would have the ability to execute searches, albeit slow, very early in the process, say in a number of days, instead of maybe a year. Then over time, actual search patterns would be used as a basis for creating an index configuration optimized towards those search patterns, thereby improving the search performance.

1. A method for interfacing information search, analysis, and report applications in system for search and retrieval of information in record or content repositories containing complex structured records or content, wherein the repository is searchable and comprises schema paths for record or content attributes, wherein the method comprises:
applying a search query for one or more attribute values to an index of attribute values, retrieving a result set of records or content which matches said one or more attribute values;
extracting schema paths associated with matching records or content, said schema paths comprising one or more distinct elements selected among a server address, a database name, a record or an attribute name;
computing summary information of the extracted schema paths; and
applying the computed summary information for creating an index based on search-driven schema discovery (SDSD index).

2. A method according to claim 1, further comprising keeping only single values for unique attributes of records in the repository.

3. A method according to claim 1, further comprising retrieving the search result on the basis of one of an identical or exact match, a partial or approximate match, or by being included in a concept class for said one or more attribute values.

4. A method according to claim 3, characterized by specifying a concept class as a person or an organization.

5. A method according to claim 1, further comprising applying the search query with linguistic normalization in order to improve recall in the search result.

6. A method according to claim 5, further comprising performing linguistic normalization with one or more of lemmatization, spell checking, phonetic matching, synonyms or homeosemies.

7. A method according to claim 1, further comprising constructing an information retrieval specification on the basis of the computed summary information.

8. A method according to claim 7, further comprising formulating the information retrieval specification as an SQL or XQuery statement.

9. A method according to claim 8, further comprising transferring information from the repository to another information search and retrieval system by means of an SQL statement.

10. The method of claim 9, wherein said another information search and retrieval system being one of a database, a data warehouse, a reporting system, a search engine service or an application API.

11. A method according to claim 1, further comprising using the computed summary information as an aid for result navigation in the information search and retrieval system.

12. A method according to claim 11, further comprising presenting the result navigation as a list of associated schema paths.

13. A method according to claim 12, further comprising including occurrence frequency information in the list of schema paths.

14. A method according to claim 11, further comprising gathering access information relating to a performed search application by means of the computed summary information, establishing one or more access templates on the basis of the gathered access information, and deploying said one or more access templates in the information search and retrieval system for improving future search applications in the system.
